(19) United States
(12) Patent Application Publication
(10) Pub. No.: US 2025/0138347 A1
(43) Pub. Date: May 1, 2025

(54) SEMICONDUCTOR OPTICAL INTEGRATED DEVICE

(71) Applicant: Mitsubishi Electric Corporation, Tokyo (JP)

(72) Inventors: Asami UCHIYAMA, Tokyo (JP); Yoshimichi MORITA, Tokyo (JP); Shinya OKUDA, Tokyo (JP)

(73) Assignee: Mitsubishi Electric Corporation, Tokyo (JP)

(21) Appl. No.: 18/730,149

(22) PCT Filed: Jun. 10, 2022
(86) PCT No.: PCT/JP2022/023456

§ 371 Date: Jul. 18, 2024

(51) Int. Cl. G02F 1/015; G02F 1/01; G02F 1/017

(52) U.S. Cl. CPC G02F 1/0157; G02F 1/0123; G02F 1/017

(57) ABSTRACT

An EA modulator (101) and a termination resistor (102) are monolithically integrated on a substrate (1). The termination resistor (102) is electrically connected in parallel to the EA modulator (101). The termination resistor (102) is made of semiconductor material. A length of the termination resistor (102) is 0.5 to 1.5 times a length of the EA modulator (101). The termination resistor (102) is arranged in parallel to the EA modulator (101) in plan view.

### FIELD

The present disclosure relates to a semiconductor optical integrated device for optical communication systems.

### BACKGROUND

In recent years, as communications traffic continues to grow, there has been a need for an uncooled EA modulator. In general, an absorption edge wavelength of an EA modulator becomes shorter with a decrease in temperature. Therefore, when the EA modulator is driven uncooled, an extinction ratio decreases on a low temperature side. In order to solve this, it is considered to rely on Joule heat that is generated in a termination resistor for impedance matching to prevent a decrease in temperature of the EA modulator. Conventionally, there has been technology to monolithically integrate an EA modulator and a termination resistor (see, for example, PTL 1).

### CITATION LIST

### Patent Literature

[PTL 1] JP 2004-126108 A

### SUMMARY

### Technical Problem

However, in the conventional technology, the length of the termination resistor that generates heat was much smaller than the length of the EA modulator. Moreover, the area of an electrode pad and the like was larger than the area of the termination resistor, and heat was easily dissipated through the electrode pad and the like. Therefore, with the conventional technology, it was difficult to rely on the Joule heat of the termination resistor to reduce a decrease in temperature of the EA modulator. As a result, an uncooled operation was not possible over a wide range of temperatures.

An object of the present disclosure, which has been made to solve the above problems, is to obtain a semiconductor optical integrated device that enables an uncooled operation over a wide range of temperatures.

### Solution to Problem

A semiconductor optical integrated device according to the present disclosure includes: a substrate; an EA modulator, and a termination resistor electrically connected in parallel to the EA modulator, wherein the EA modulator and the termination resistor are monolithically integrated on the substrate, the termination resistor is made of semiconductor material, a length of the termination resistor is 0.5 to 1.5 times a length of the EA modulator, and the termination resistor is arranged in parallel to the EA modulator in plan view.

### Advantageous Effects of Invention

In the present disclosure, the termination resistor has the same length as the EA modulator, and is arranged in parallel to the EA modulator. This makes it possible to uniformly transfer heat from the termination resistor to the EA modulator in the direction of a resonator, and improve temperature characteristics. Consequently, it is possible to perform an uncooled operation over a wide range of temperatures.

### BRIEF DESCRIPTION OF THE DRAWINGS

FIG. 1 is a top view showing a semiconductor optical integrated device according to Embodiment 1.

FIG. 2 is a sectional view taken along I-II in FIG. 1.

FIG. 3 is a sectional view taken along II-IV in FIG. 1.

FIG. 4 is a sectional view taken along V-VI in FIG. 1.

FIG. 5 is a view showing the relationship among the termination resistor width, carrier concentration, and resistance value.

FIG. 6 is an equivalent circuit diagram showing an apparatus for driving the semiconductor optical integrated device according to Embodiment 1.

FIG. 7 is a view showing the DC bias at each temperature.

FIG. 8 is a view showing the DC bias dependence of temperature increase of the EA modulator absorption layer.

FIG. 9 is a top view showing a semiconductor optical integrated device according to Embodiment 2.

FIG. 10 is a sectional view taken along I-II in FIG. 9.

FIG. 11 is a sectional view taken along III-IV in FIG. 9.

FIG. 12 is a sectional view taken along V-VI in FIG. 9.

FIG. 13 is a top view showing a semiconductor optical integrated device according to Embodiment 3.

FIG. 14 is a sectional view taken along I-II in FIG. 13.

FIG. 15 is a sectional view taken along III-IV in FIG. 13.

FIG. 16 is a sectional view taken along V-VI in FIG. 13.

FIG. 17 is a sectional view taken along VII-VIII in FIG. 13.

FIG. 18 is a top view showing a semiconductor optical integrated device according to Embodiment 4.

FIG. 19 is a top view showing a semiconductor optical integrated device according to Embodiment 5.

FIG. 20 is a top view showing a semiconductor optical integrated device according to Embodiment 6.

FIG. 21 is a sectional view taken along I-II in FIG. 20.

FIG. 22 is a sectional view taken along III-IV in FIG. 20.

FIG. 23 is a sectional view taken along V-VI in FIG. 20.

FIG. 24 is a sectional view taken along VII-VIII in FIG. 20.

### DESCRIPTION OF EMBODIMENTS

A semiconductor optical integrated device according to the embodiments of the present disclosure will be described with reference to the drawings. The same components will be denoted by the same symbols, and the repeated description thereof may be omitted.

### Embodiment 1

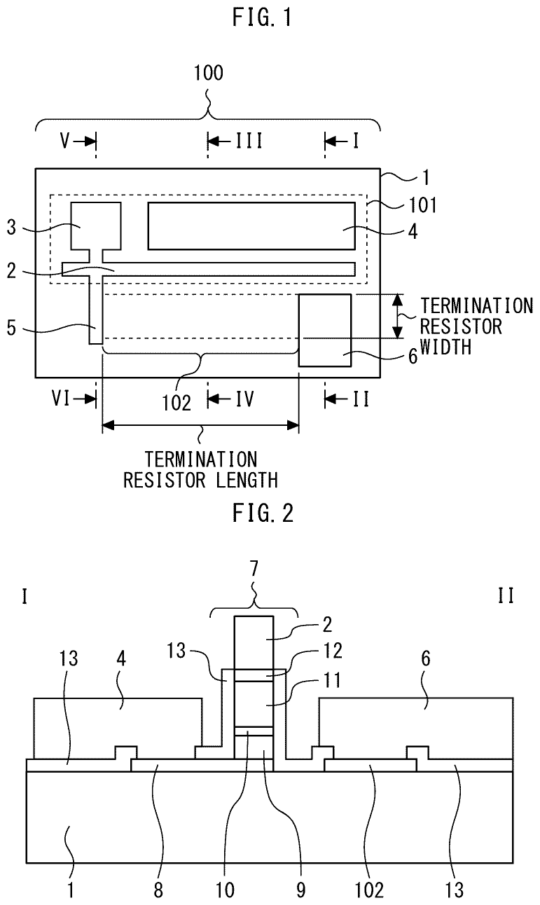

FIG. 1 is a top view showing a semiconductor optical integrated device according to Embodiment 1. In a semiconductor optical integrated device 100, an electro-absorption (EA) modulator 101 for single-phase driving and a termination resistor 102 are monolithically integrated on a semi-insulating InP substrate 1. The termination resistor 102 is provided for impedance matching.

An anode of the EA modulator 101 is connected through an electrode 2 to a signal-side pad 3 on the signal side. A cathode of the EA modulator 101 is connected to a GND pad 4. One end of the termination resistor 102 is connected to the anode of the EA modulator 101 through the electrodes 2, 5 on the signal side. Another end of the termination resistor 102 is connected to a GND pad 6. The other end of the termination resistor 102 is connected to the cathode of the EA modulator 101 through the GND pad 6 and the GND pad 4. Consequently, the termination resistor 102 is electrically connected in parallel to the EA modulator 101.

The termination resistor 102 is made of, for example, n-type InGaAs. Materials for the termination resistor 102 are not limited to this, and it is possible to use a semiconductor material that can be grown epitaxially on the semi-insulating InP substrate 1. For example, it is possible to use a single-layer film of n-type InP, p-type InP, p-type InGaAs, or the like, or an epitaxial film having a plurality of materials stacked in layers. Note, however, that ohmic contacts are necessary on the signal side and the GND side of the termination resistor 102.

The length of the termination resistor 102 is 0.5 to 1.5 times the length of the EA modulator 101. The termination resistor 102 is arranged in parallel to the EA modulator 101 in plan view. A resistance value of the termination resistor 102 made of semiconductor material increases on a low temperature side, and decreases on a high temperature side.

FIG. 2 is a sectional view taken along I-II in FIG. 1. On the semi-insulating InP substrate 1, a mesa stripe 7 of the EA modulator 101 is formed along a travel direction of light. The mesa stripe 7 includes an n-type contact layer 8, an n-type cladding layer 9, an EA modulator absorption layer 10, a p-type cladding layer 11, and a p-type contact layer 12 stacked in this order on the semi-insulating InP substrate 1. The electrode 2 is formed on the p-type contact layer 12. An insulating film 13 covers sides of the mesa stripe 7. The EA modulator absorption layer 10 has a multiple quantum well (MQW) structure.

The n-type contact layer 8 is drawn to a side and connected to the GND pad 4. The termination resistor 102 is formed on the opposite side of the mesa stripe 7 from the GND pad 4. The GND pad 6 is formed on the termination resistor 102.

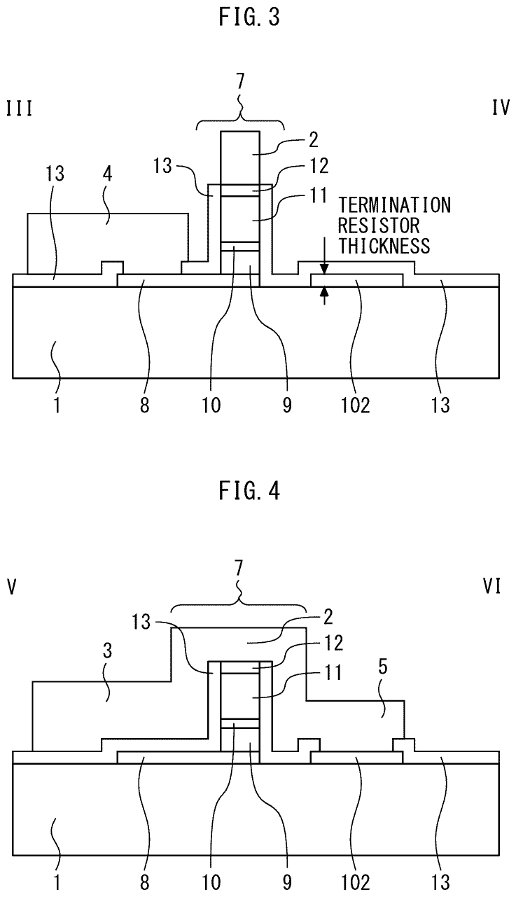

FIG. 3 is a sectional view taken along III-IV in FIG. 1. This sectional view shows a section of a central portion of the termination resistor 102. A surface of the termination resistor 102 is covered with the insulating film 13.

FIG. 4 is a sectional view taken along V-VI in FIG. 1. The signal-side pad 3 is formed on a side of the mesa stripe 7, and is connected to the electrode 2. The electrode 5 is formed on the termination resistor 102, on the opposite side of the mesa stripe 7 from the signal-side pad 3, and is connected to the electrode 2.

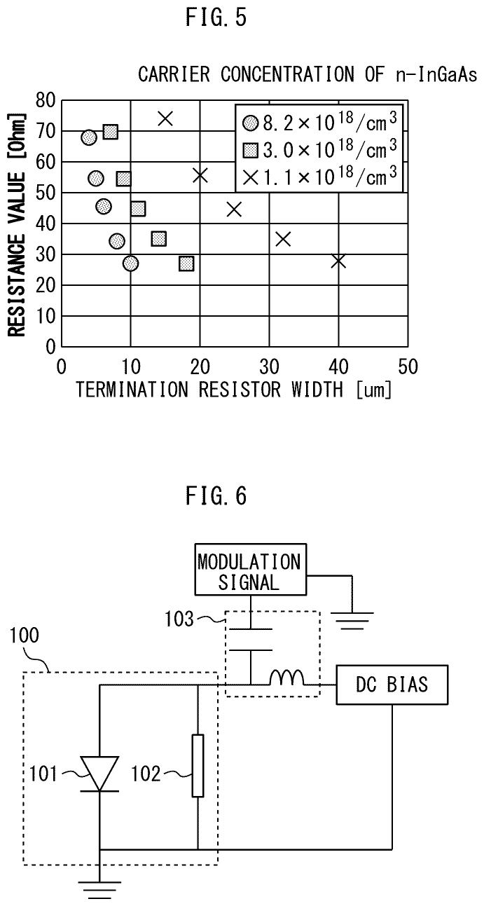

FIG. 5 is a view showing the relationship among the termination resistor width, carrier concentration, and resistance value. The termination resistor 102 is n-type InGaAs with a length of 100 μm and a thickness of 1 μm. Generally, as the resistance value of the termination resistor of the EA modulator, a value around 50Ω is often selected for single-phase driving. A desired resistance value of around 50 S can be obtained by selecting a width of the termination resistor and a carrier concentration, based on the relationship in FIG. 5.

As a method for manufacturing an optical semiconductor integrated device according to the present embodiment, there is a method that uses part of the n-type contact layer 8 as the termination resistor 102. For example, the n-type contact layer 8, the n-type cladding layer 9, the EA modulator absorption layer 10, the p-type cladding layer 11, and the p-type contact layer 12 are caused to grow epitaxially in this order on the semi-insulating InP substrate 1. Next, a high mesa ridge portion of the EA modulator 101 is patterned by using a transfer technique, and the n-type cladding layer 9, the EA modulator absorption layer 10, the p-type cladding layer 11, and the p-type contact layer 12 are removed by etching. Subsequently, the n-type contact layer 8 and the termination resistor 102 are patterned again. Next, the insulating film 13, the electrodes 2, 5, the signal-side pad 3, and the GND pads 4, 6 are patterned by using general film formation, transfer, and processing techniques to produce the optical semiconductor integrated device according to the present embodiment.

As another method for manufacturing an optical semiconductor integrated device according to the present embodiment, there is a method in which, after patterning the termination resistor 102, a layer of the EA modulator 101 is caused to grow again. For example, a layer of the termination resistor 102 is caused to grow epitaxially on the semi-insulating InP substrate 1. Next, an unnecessary epitaxial layer is removed by patterning the termination resistor 102. Thereafter, in a state in which the portion of the termination resistor 102 is covered with a mask, the n-type contact layer 8, the n-type cladding layer 9, the EA modulator absorption layer 10, the p-type cladding layer 11, and the p-type contact layer 12 are caused to grow epitaxially. Then, the EA modulator 101 is formed by a method similar to the above and the insulating film 13, the electrodes 2, 5, the signal-side pad 3, and the GND pads 4, 6 are patterned by using general film formation, transfer, and processing techniques to produce the optical semiconductor integrated device according to the present embodiment.

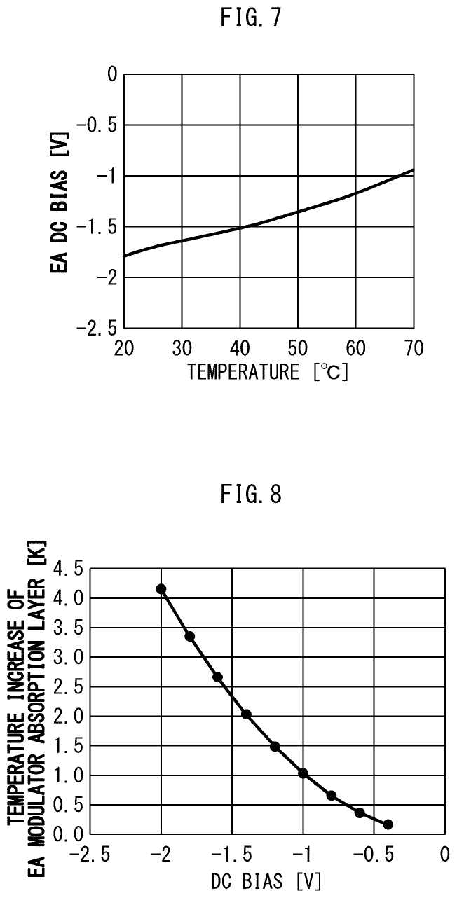

FIG. 6 is an equivalent circuit diagram showing an apparatus for driving the semiconductor optical integrated device according to Embodiment 1. A bias tee 103 applies a DC bias and a modulation signal to the semiconductor optical integrated device 100. FIG. 7 is a view showing the DC bias at each temperature. Conditions for the DC bias are selected so as to maintain the extinction ratio constant between temperatures. This temperature dependence is due to the fact that the higher the temperature, the longer the wavelength of the absorption spectrum of the EA modulator, which is a generally known phenomenon.

In the present embodiment, since the absolute value of bias applied to the termination resistor 102 is greater on the low temperature side, the amount of heat generated in the termination resistor 102 is greater on the low temperature side. Joule heat of the termination resistor 102 is propagated to the EA modulator 101 through the semi-insulating InP substrate 1. Consequently, changes in temperature of the EA modulator absorption layer 10 of the semiconductor optical integrated device 100 are smaller than changes in ambient temperature.

FIG. 8 is a view showing the DC bias dependence of temperature increase of the EA modulator absorption layer. The termination resistor 102 has a length of 100 μm, a width of 20 μm, a thickness of 1 μm, a distance of 10 μm from the EA modulator 101, and a resistance value of 50Ω. When the DC bias is 1.8 V at 20° C. as shown in FIG. 7, the temperature increase is about 3.3° C. Moreover, when the DC bias is −0.9 V at 70° C. as shown in FIG. 7, the temperature increase is about 0.8° C. Therefore, when the difference in ambient temperature is 70° C.−20° C.=50° C., the difference in the temperature of the EA modulator absorption layer 10 is about 47.5° C.

As explained above, in the present embodiment, the termination resistor 102 has the same length as the EA modulator 101, and is arranged in parallel to the EA modulator 101. This makes it possible to uniformly transfer heat from the termination resistor 102 to the EA modulator 101 in the direction of a resonator, and improve temperature characteristics. Consequently, it is possible to perform an uncooled operation over a wide range of temperatures.

Further, in order to sufficiently transfer the Joule heat of the termination resistor 102 to the EA modulator 101, the distance between the EA modulator 101 and the termination resistor 102 is preferably 10 μm or less. Note that whether or not a sufficient effect can be obtained depends on designs such as the length of the EA modulator 101, and the length, thickness, and width of the termination resistor 102.

Note that not only the EA modulator 101 and the termination resistor 102, but also a semiconductor device such as a laser, SOA, and PD may be monolithically integrated. Moreover, for optical coupling, a semiconductor passive waveguide of a spot size converter or a directional coupler may be monolithically formed. Further, the EA modulator 101 is not limited to a high-mesa shape, and may be a buried waveguide, or a low-mesa ridge type. Furthermore, although the n-type contact layer 8 of the EA modulator 101 was formed on the semi-insulating InP substrate 1 side, the p-type contact layer 12 of the EA modulator 101 may be formed on the semi-insulating InP substrate 1 side.

### Embodiment 2

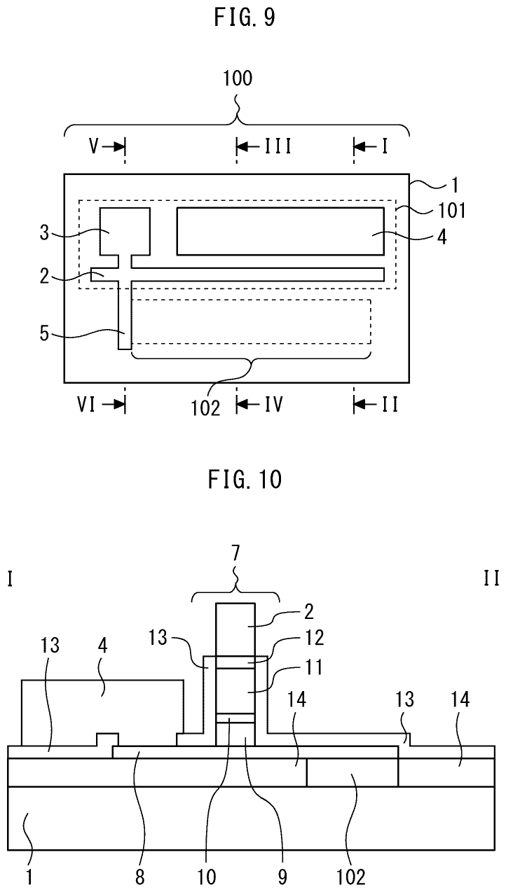

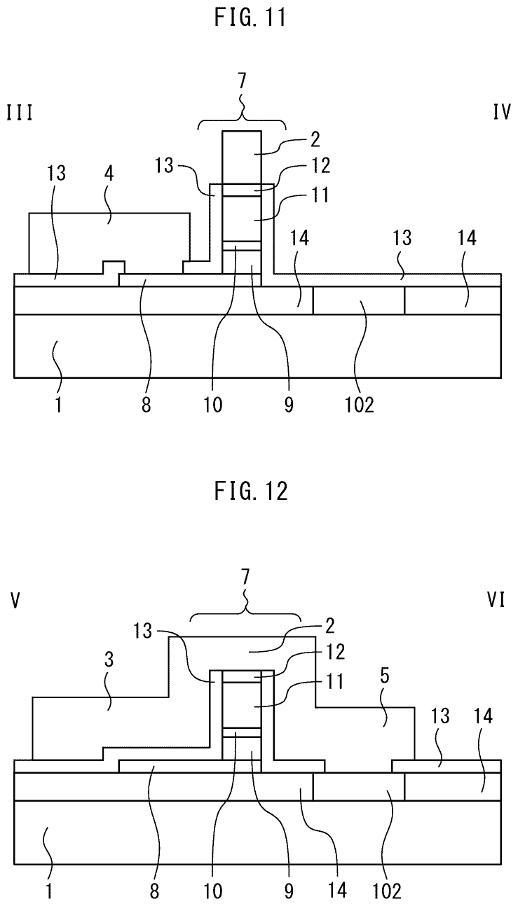

FIG. 9 is a top view showing a semiconductor optical integrated device according to Embodiment 2. FIG. 10 is a sectional view taken along I-II in FIG. 9. FIG. 11 is a sectional view taken along III-IV in FIG. 9. FIG. 12 is a sectional view taken along V-VI in FIG. 9. Hereinafter, the difference from Embodiment 1 will be mainly explained.

Both sides of the termination resistor 102 are buried in a semi-insulating InP layer 14. A top surface of the termination resistor 102 and the n-type contact layer 8 are electrically connected. As shown in FIG. 11, in a central portion of the termination resistor 102, the top surface of the termination resistor 102 and the n-type contact layer 8 are not connected. Note that since the n-type contact layer 8 is formed on the termination resistor 102, materials other than semiconductors cannot be selected as the material for the termination resistor 102.

The GND pad 6 was connected to the other end of the termination resistor 102 in Embodiment 1, but, in the present embodiment, the cathode of the EA modulator 101 and the other end of the termination resistor 102 are electrically connected by the n-type contact layer 8, without providing an electrode pad. Consequently, since heat dissipation from metal of an electrode pad is reduced, heat generated in the termination resistor 102 can be more efficiently used than in Embodiment 1. As a result, it is possible to perform an uncooled operation over a wider range of temperatures.

### Embodiment 3

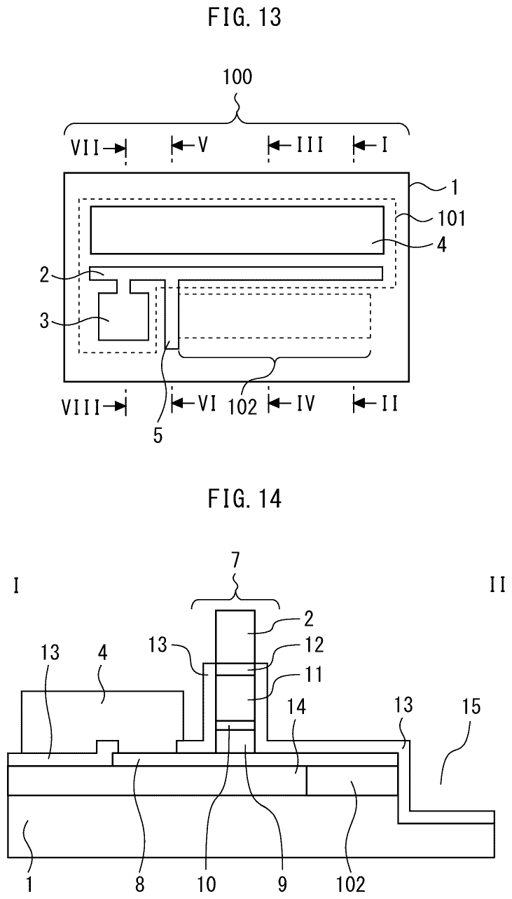

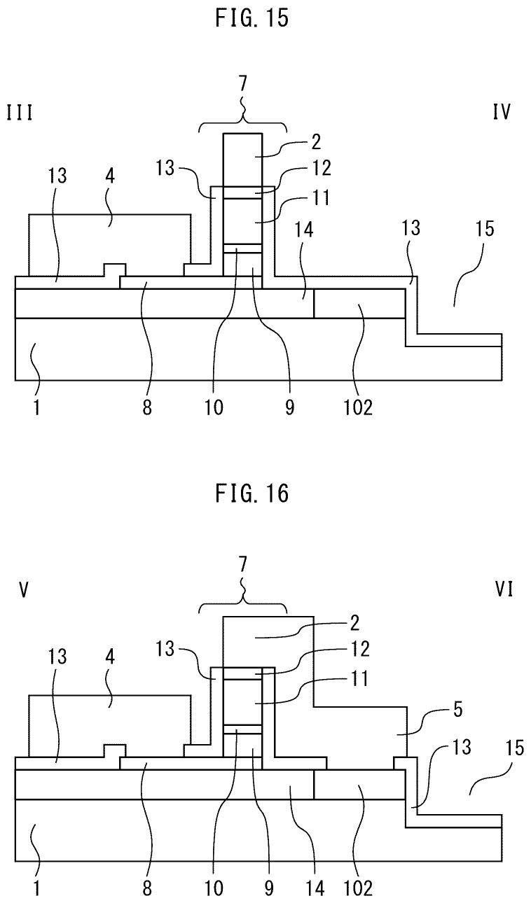

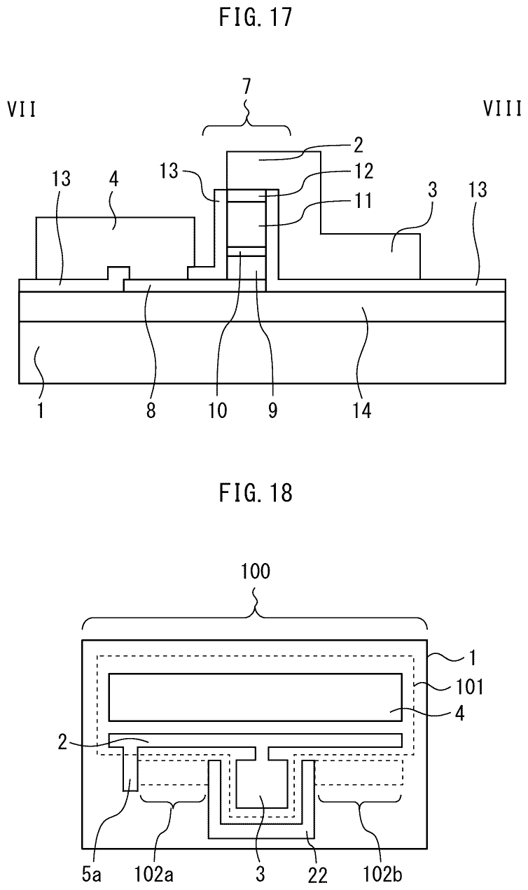

FIG. 13 is a top view showing a semiconductor optical integrated device according to Embodiment 3. FIG. 14 is a sectional view taken along I-II in FIG. 13. FIG. 15 is a sectional view taken along III-IV in FIG. 13. FIG. 16 is a sectional view taken along V-VI in FIG. 13. FIG. 17 is a sectional view taken along VII-VIII in FIG. 13. Hereinafter, the difference from Embodiment 2 will be explained.

The termination resistor 102 and the signal-side pad 3 are formed on the same side with respect to the mesa stripe 7. A groove 15 is formed in the semi-insulating InP layer 14 and the semi-insulating InP substrate 1 along one of two sides of the termination resistor 102 parallel to the EA modulator 101, the side being farther from the mesa stripe 7 of the EA modulator 101. Consequently, since heat dissipation from the termination resistor 102 toward the opposite side of the mesa stripe 7 is reduced, heat generated in the termination resistor 102 can be more efficiently used than in Embodiment 2. As a result, it is possible to perform an uncooled operation over a wider range of temperatures.

### Embodiment 4

FIG. 18 is a top view showing a semiconductor optical integrated device according to Embodiment 4. The EA modulator 101 and first and second termination resistors 102a, 102b are monolithically integrated on the semi-insulating InP substrate 1. The first and second termination resistors 102a, 102b are electrically connected to each other in series. The total length of the first and second termination resistors 102a, 102b is 0.5 to 1.5 times the length of the EA modulator 101. Each of the termination resistors 102a. 102b is arranged in parallel to the EA modulator 101 in plan view, and is at an equal distance from the EA modulator 101.

One end of the termination resistor 102a is connected to the anode of the EA modulator 101 through the electrode 5a and the electrode 2. Another end of the termination resistor 102a and one end of the termination resistor 102b are connected through an electrode 22. Another end of the termination resistor 102b is connected to the cathode of the EA modulator 101 in a manner similar to Embodiment 2.

In the present embodiment, by disposing the first and second termination resistors 102a, 102b in a split manner, heat is uniformly transferred to the EA modulator 101 in the direction of the resonator, and temperature characteristics can be further improved than in Embodiments 1 to 3. Note that it is also possible to make a design to obtain desired characteristics by creating a heat generation amount distribution in the direction of the resonator. Furthermore, by appropriately designing a shape of the electrode 22, inductance can be added, and the degree of freedom in high frequency design is increased.

### Embodiment 5

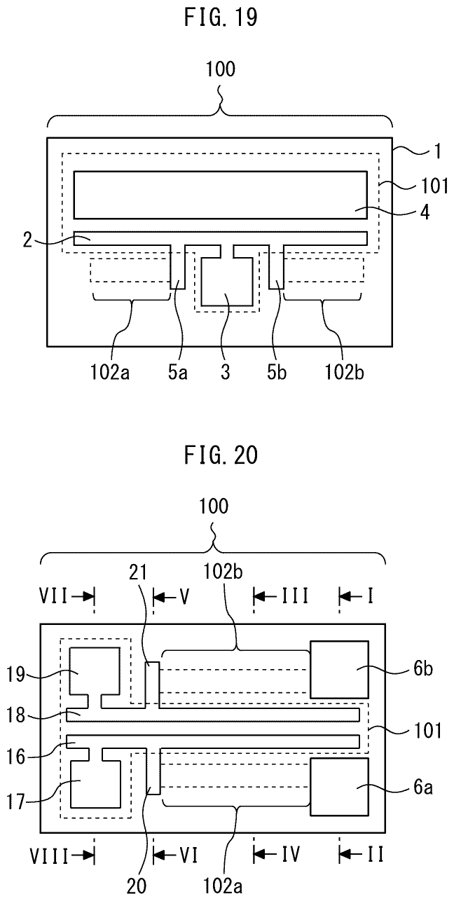

FIG. 19 is a top view showing a semiconductor optical integrated device according to Embodiment 5. The EA modulator 101 and the first and second termination resistors 102a. 102b are monolithically integrated on the semi-insulating InP substrate 1. The first and second termination resistors 102a, 102b are electrically connected to each other in parallel, and are also electrically connected to the EA modulator 101 in parallel. The total length of the first and second termination resistors 102a, 102b is 0.5 to 1.5 times the length of the EA modulator 101. Each of the termination resistors 102a. 102b is arranged in parallel to the EA modulator 101 in plan view, and is at an equal distance from the EA modulator 101.

One end of the termination resistor 102a is connected to the anode of the EA modulator 101 through an electrode 5a and the electrode 2. One end of the termination resistor 102b is connected to the anode of the EA modulator 101 through an electrode 5b and the electrode 2. The other ends of the first and second termination resistors 102a, 102b are connected to the cathode of the EA modulator 101 in a manner similar to Embodiment 2.

In the present embodiment, by disposing the first and second termination resistors 102a, 102b in a split manner, heat is uniformly transferred to the EA modulator 101 in the direction of the resonator, and temperature characteristics can be further improved than in Embodiments 1 to 3. Note that it is also possible to make a design to obtain desired characteristics by creating a heat generation amount distribution in the direction of the resonator.

### Embodiment 6

FIG. 20 is a top view showing a semiconductor optical integrated device according to Embodiment 6. In the semiconductor optical integrated device 100, the EA modulator 101 for differential driving and the first and second termination resistors 102a, 102b are monolithically integrated on the semi-insulating InP substrate 1.

The anode of the EA modulator 101 is connected through an electrode 16 to an electrode pad 17. The cathode of the EA modulator 101 is connected through an electrode 18 to an electrode pad 19. One end of the first termination resistor 102a is connected through an electrode 20 to the electrode 16. Another end of the first termination resistor 102a is connected to a first GND pad 6a. One end of the second termination resistor 102b is connected through an electrode 21 to the electrode 18. Another end of the second termination resistor 102b is connected to a second GND pad 6b.

Like the termination resistor 102, the first and second termination resistors 102a. 102b are made of semiconductor material. The total length of the first and second termination resistors 102a, 102b is 0.5 to 1.5 times the length of the EA modulator 101. The first and second termination resistors 102a, 102b are arranged in parallel to the EA modulator 101 in plan view.

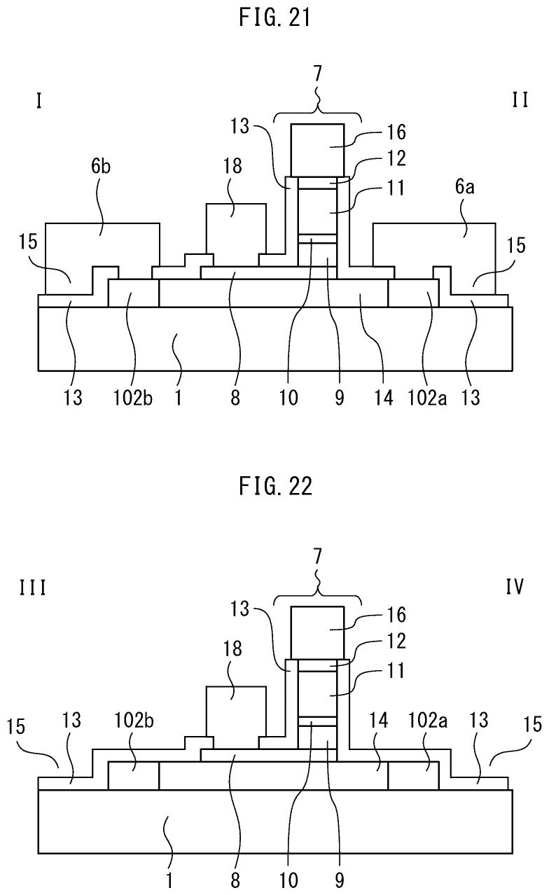

FIG. 21 is a sectional view taken along I-II in FIG. 20. The mesa stripe 7 is formed between the first termination resistor 102a and the second termination resistor 102b. The configuration of the mesa stripe 7 is the same as in Embodiment 1. The electrode 16 is formed on the p-type contact layer 12. The n-type contact layer 8 is drawn to a side, and is connected to the electrode 18. The first GND pad 6a is formed on the first termination resistor 102a. The second GND pad 6b is formed on the second termination resistor 102b.

FIG. 22 is a sectional view taken along III-IV in FIG. 20. This sectional view shows a section of a central portion of the first and second termination resistors 102a. 102b. The surfaces of the first and second termination resistors 102a. 102b are covered with the insulating film 13, and are not connected to the first GND pad 6a and the second GND pad 6b.

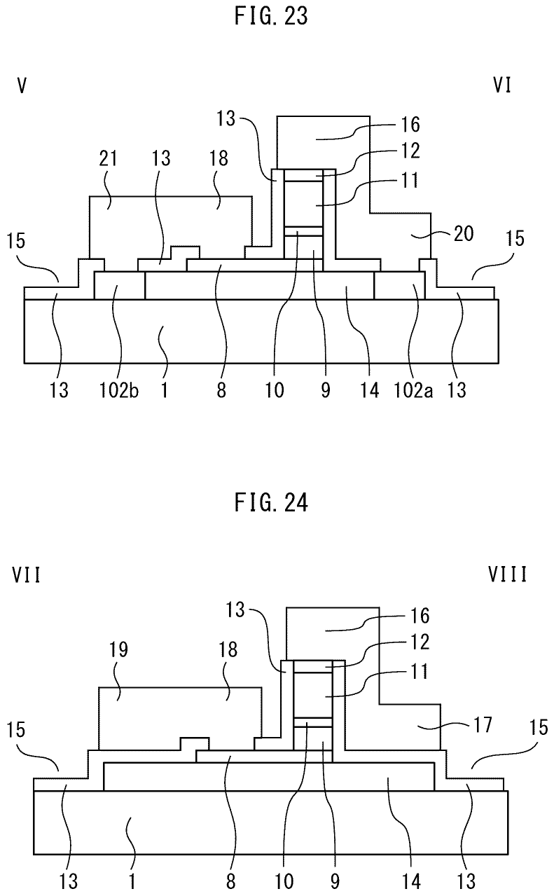

FIG. 23 is a sectional view taken along V-VI in FIG. 20. The electrode 20 is formed on the first termination resistor 102a. The electrode 21 is formed on the second termination resistor 102b. FIG. 24 is a sectional view taken along VII-VIII in FIG. 20. The electrode 16 is connected to the electrode pad 17. The electrode 18 is connected to the electrode pad 19.

In the present embodiment, the first and second termination resistors 102a, 102b have the same length as the EA modulator 101, and are arranged in parallel to the EA modulator 101. This makes it possible to uniformly transfer heat from the first and second termination resistors 102a, 102b to the EA modulator 101 in the direction of the resonator, and improve temperature characteristics. Consequently, like the EA modulator for single-phase driving of Embodiment 1, even with the EA modulator for differential driving, it is possible to perform an uncooled operation over a wide range of temperatures.

Moreover, in order to sufficiently transfer Joule heat of the first and second termination resistors 102a. 102b to the EA modulator 101, the distances between the EA modulator 101 and each of the first and second termination resistors 102a, 102b are preferably 10 μm or less. Note that whether or not a sufficient effect is obtained depends on designs such as the length of the EA modulator 101, and the length, thickness, and width of each of the first and second termination resistors 102a. 102b.

Further, the cathode of the EA modulator 101 and the other end of the second termination resistor 102b are electrically connected by the n-type contact layer 8, without providing electrode pads. Consequently, since heat dissipation from metal of electrode pads is reduced, the heat generated in the second termination resistor 102b can be more efficiently used.

Furthermore, the groove 15 is formed in the semi-insulating InP layer 14 along one of two sides of the first termination resistor 102a parallel to the EA modulator 101, the side being farther from the mesa stripe 7 of the EA modulator 101. The groove 15 is also formed in the semi-insulating InP layer 14 along one of two sides of the second termination resistor 102b parallel to the EA modulator 101, the side being farther from the mesa stripe 7 of the EA modulator 101. Consequently, heat dissipation from the first and second termination resistors 102a, 102b toward the opposite side of the mesa stripe 7 is reduced. As a result, it is possible to obtain the same effect as that of Embodiment 2.

### REFERENCE SIGNS LIST

1 semi-insulating InP substrate (substrate); 6a first GND pad; 6b second GND pad; 8 n-type contact layer (semiconductor material); 14 semi-insulating InP layer (semi-insulating layer); 15 groove; 100 semiconductor optical integrated device; 101 EA modulator; 102 termination resistor; 102a first termination resistor; 102b second termination resistor

1. (canceled)

2. A semiconductor optical integrated device comprising:
a substrate;
an EA modulator; and
a termination resistor electrically connected in parallel to the EA modulator,
wherein the EA modulator and the termination resistor are monolithically integrated on the substrate,
the termination resistor is made of semiconductor material,
a length of the termination resistor is 0.5 to 1.5 times a length of the EA modulator,
the termination resistor is arranged in parallel to the EA modulator in plan view, and
a distances between the EA modulator and the termination resistor is 10 μm or less.

3. A semiconductor optical integrated device comprising:
a substrate;
an EA modulator; and
a termination resistor electrically connected in parallel to the EA modulator,
wherein the EA modulator and the termination resistor are monolithically integrated on the substrate,
the termination resistor is made of semiconductor material,
a length of the termination resistor is 0.5 to 1.5 times a length of the EA modulator,
the termination resistor is arranged in parallel to the EA modulator in plan view, and
a cathode of the EA modulator and the termination resistor are electrically connected by a semiconductor material.

4. The semiconductor optical integrated device according to claim 2, further comprising a semi-insulating layer burying the termination resistor,
wherein a groove is formed in the semi-insulating layer along one of two sides of the termination resistor parallel to the EA modulator, the side being farther from the EA modulator.

5. The semiconductor optical integrated device according to claim 2, wherein the termination resistor includes a plurality of resistors connected to each other in series,
a total length of the plurality of resistors is 0.5 to 1.5 times the length of the EA modulator, and
each of the plurality of resistors is arranged in parallel to the EA modulator in plan view, and is at an equal distance from the EA modulator.

6. The semiconductor optical integrated device according to claim 2, wherein the termination resistor includes a plurality of resistors connected to each other in parallel,
a total length of the plurality of resistors is 0.5 to 1.5 times the length of the EA modulator, and
each of the plurality of resistors is arranged in parallel to the EA modulator in plan view, and is at an equal distance from the EA modulator.

7. A semiconductor optical integrated device comprising:
a substrate;
an EA modulator for differential driving;
a first termination resistor having one end connected to an anode of the EA modulator;
a second termination resistor having one end connected to a cathode of the EA modulator;
a first GND pad connected to another end of the first termination resistor; and
a second GND pad connected to another end of the second termination resistor,
wherein the EA modulator and the first and second termination resistors are monolithically integrated on the substrate,
the first and second termination resistors are made of semiconductor material,
lengths of the first and second termination resistors are 0.5 to 1.5 times a length of the EA modulator, and
the first and second termination resistors are arranged in parallel to the EA modulator in plan view.

8. The semiconductor optical integrated device according to claim 7, wherein distances between the EA modulator and each of the first and second termination resistors are 10 μm or less.

9. The semiconductor optical integrated device according to claim 7, wherein a cathode of the EA modulator and one end of the second termination resistor are electrically connected by a semiconductor material.

10. The semiconductor optical integrated device according to claim 7, further comprising a semi-insulating layer burying the first and second termination resistors,
wherein a groove is formed in the semi-insulating layer along one of two sides of the first termination resistor parallel to the EA modulator, the side being farther from the EA modulator, and
a groove is formed in the semi-insulating layer along one of two sides of the second termination resistor parallel to the EA modulator, the side being farther from the EA modulator.

11. The semiconductor optical integrated device according to claim 3, further comprising a semi-insulating layer burying the termination resistor,
wherein a groove is formed in the semi-insulating layer along one of two sides of the termination resistor parallel to the EA modulator, the side being farther from the EA modulator.

12. The semiconductor optical integrated device according to claim 3, wherein the termination resistor includes a plurality of resistors connected to each other in series,
a total length of the plurality of resistors is 0.5 to 1.5 times the length of the EA modulator, and
each of the plurality of resistors is arranged in parallel to the EA modulator in plan view, and is at an equal distance from the EA modulator.

13. The semiconductor optical integrated device according to claim 3, wherein the termination resistor includes a plurality of resistors connected to each other in parallel,
a total length of the plurality of resistors is 0.5 to 1.5 times the length of the EA modulator, and
each of the plurality of resistors is arranged in parallel to the EA modulator in plan view, and is at an equal distance from the EA modulator.
